(19) United States
(12) Patent Application Publication
(10) Pub. No.: US 2024/0302226 A1
(43) Pub. Date: Sep. 12, 2024

(54) STRAIN MEASURING SYSTEM

(71) Applicant: TDK Corporation, Tokyo (JP)

(72) Inventors: Tetsuya SASAHARA, Tokyo (JP); Ken UNNO, Tokyo (JP); Masanori KOBAYASHI, Tokyo (JP); Tetsuo HATA, Tokyo (JP); Lucie OUEDRAOGO, Tokyo (JP)

(73) Assignee: TDK Corporation, Tokyo (JP)

(21) Appl. No.: 18/599,247

(22) Filed: Mar. 8, 2024

(30) Foreign Application Priority Data
Mar. 9, 2023 (JP) 2023-036380

(51) Int. Cl. G01L 1/22; G01L 1/16

(52) U.S. Cl. CPC G01L 1/2262; G01L 1/16; G01L 1/2281

(57) ABSTRACT

A strain measuring system includes a piezoelectric element and a resistor provided on an object. The system also includes a resistance detection circuit to detect a change in resistance of the resistor, and a piezoelectric effect detection circuit to detect a piezoelectric effect of the piezoelectric element. A strain calculation circuit detects a strain changing time while the strain of the object is changing using a detection result from the piezoelectric effect detection circuit, calculates a change in resistance of the resistor during the strain changing time, and calculates a degree of strain of the object using a calculation result of the change in resistance.

### CROSS-REFERENCE TO RELATED APPLICATION

This application claims priority to Japanese patent application No. 2023-036380, filed on Mar. 9, 2023, which is incorporated herein by reference in its entirety.

### BACKGROUND

The present disclosure relates to a strain measuring system for measuring strain of an object.

As for a strain gauge to measure strain of the object to be measured, those using an electrical resistance method is widely used which detects strain from a change in resistance accompanying a deformation of resistor. However, a resistance of resistor changes not only due to strain but also due to temperature. Thus, in order to accurately detect strain using such strain gauge, it is necessary to remove a resistance change component caused specifically by strain from an overall change in resistance.

For example, regarding a strain detection sensor of a conventional electrical resistance type, there is a method of detecting strain of the object by adding a resistor for temperature change detection in addition to a resistor for strain detection which is not affected by strain of the object in order to remove the effect of the temperature change calculated from an output of the temperature detection resistor.
[Patent Document 1] JP Patent Application Laid Open No. 2000-111368

### SUMMARY

Regarding a conventional strain detection system, there is a possibility of a detection error, since resistance may change due to factors other than strain of the object and an atmosphere temperature change, such as self-heating of the resistor, a change in resistance over time, and so on. Also, regarding the conventional strain detection sensor, power consumption becomes larger in order to detect both resistance of a strain detection resistor and resistance of a temperature detection resistor.

Thus, it is desirable to provide a strain detection system capable of effectively detecting a resistance change caused by strain and also capable of suppressing a power consumption.

Accordingly, in an exemplary aspect, the strain measuring system according to the present disclosure, includes a piezoelectric element and a resistor provided on an object. The system also includes a resistance detection circuit to detect a change in resistance of the resistor, and a piezoelectric effect detection circuit to detect a piezoelectric effect of the piezoelectric element. A strain calculation circuit detects a strain changing time while the strain of the object is changing using a detection result from the piezoelectric effect detection circuit, calculates a change in resistance of the resistor during the strain changing time, and calculates a degree of strain of the object using a calculation result of the change in resistance.

### BRIEF DESCRIPTION OF DRAWINGS

FIG. 1 is a conceptual diagram showing a schematic configuration of a strain measuring system according to a first embodiment.

FIG. 2 is a conceptual diagram showing a circuit and signal processing of the strain measuring system shown in FIG. 1.

FIG. 3 is a conceptual diagram explaining a first example of the signal processing of the strain measuring system shown in FIG. 1 and FIG. 2.

FIG. 4 is a conceptual diagram showing a deformed sate of an object to be measured.

FIG. 5 is a conceptual diagram explaining a second example of the signal processing of the strain measuring system shown in FIG. 1 and FIG. 2.

FIG. 6 is a conceptual diagram showing a schematic configuration of a strain measuring system according to the second embodiment.

FIG. 7 is a conceptual diagram showing a third example of the signal processing of the strain measuring system shown in FIG. 6.

FIG. 8 is a conceptual diagram showing a schematic configuration of a strain measuring system according to a third embodiment.

FIG. 9 is a conceptual diagram explaining a fourth example of the signal processing of the strain measuring system shown in FIG. 8.

FIG. 10 is a conceptual diagram showing a circuit and signal processing of a strain measuring system according to a fourth embodiment.

FIG. 11 is a conceptual diagram explaining a fifth example of the signal processing of the strain measuring system shown in FIG. 10.

FIG. 12A is a conceptual diagram showing a schematic configuration of the strain measuring system according to a fifth embodiment.

FIG. 12B is a conceptual diagram showing a schematic configuration of the strain measuring system according to the fifth embodiment.

FIG. 13A is a conceptual diagram showing a schematic configuration of the strain measuring system according to a sixth embodiment.

FIG. 13B is a conceptual diagram showing a schematic configuration of the strain measuring system according to the sixth embodiment.

FIG. 14 is a conceptual diagram showing a schematic configuration of a strain measuring system according to a seventh embodiment.

FIG. 15 is a conceptual diagram showing a circuit and signal processing of the strain measuring system shown in FIG. 14.

FIG. 16 is a conceptual diagram explaining a sixth example of the signal processing of the strain measuring system shown in FIG. 14 and FIG. 15.

FIG. 17 is a conceptual diagram showing a schematic configuration of a strain measuring system according to an eighth embodiment.

FIG. 18 is a conceptual diagram showing a circuit and signal processing of the strain measuring system shown in FIG. 17.

FIG. 19 is a conceptual diagram showing a schematic configuration according to a modified example.

FIG. 20 shows an example of a circuit realizing a resistance detection unit, a piezoelectric effect detection unit, and a strain calculation unit according to the present disclosure.

FIG. 21 is a flowchart showing a processing flow in the case the function shown in FIG. 20 is realized using a computer.

FIG. 22 shows another example of a circuit realizing a resistance detection unit, a piezoelectric effect detection unit, and a strain calculation unit according to the present disclosure.

FIG. 23 is a flowchart showing a processing flow in the case the function shown in FIG. 22 is realized using a computer.

### DETAILED DESCRIPTION

Hereinbelow, the present disclosure is described based on the exemplary embodiments shown in the figures.

### First Embodiment

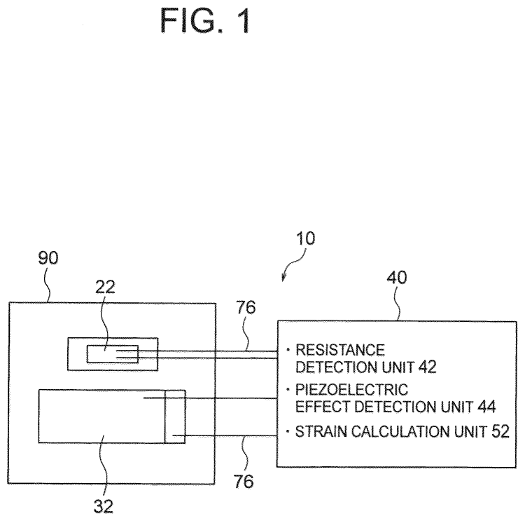

FIG. 1 is a conceptual diagram showing a schematic configuration of a strain measuring system 10 according to the first embodiment. As shown in FIG. 1, the strain measuring system 10 includes a resistor 22 and a piezoelectric element 32 which are provided on an object for strain measurement 90, and a detection operation unit 40 that includes circuitry to perform the functions described herein. The object 90 is an object for strain measurement using the strain measuring system 10. For example, as the object 90, a plate may be mentioned which may be strained depending on an angle of a robot arm, or a pressure receiving plate which may be strained depending on applied pressure. Note that, as for the object 90, as long as it can be strained, shapes and materials are not particularly limited. The same applies to other embodiments as well.

The resistor 22 is directly or indirectly fixed on a surface of the object 90 using, for example, an adhesive, and the resistor 22 itself also deforms along with deformation of the object 90. The resistor 22 is made of, for example, an alloy material of which the resistance (electrical resistance) changes according to the degree of strain, and functions as a so-called strain gauge. As a material of the resistor 22, a Ni—Cr based alloy, a Cr—Al based alloy, a Cu—Ni based alloy, and so on may be mentioned.

The resistor 22 is produced, for example, by patterning a conductive thin film made by above-mentioned metals into a predetermined form. The resistor 22 may include elements other than Ni, Cr, Cu, and Al; and for example, the resistor 22 may include O and N. Also, besides Ni, Cr, Cu, and Al, the resistor 22 may include other metal elements and base elements.

The resistor 22 is electrically connected to the detection operation unit 40 via electrodes not shown in the figure and a wiring 76. Also, the resistor 22 only needs to be fixed in a way that it can deform along with the deformation of the object 90, and other members, for example, such as a substrate, or an adhesive layer may be placed between the resistor 22 and the object 90. The same applies to the other embodiments as well.

Similar to the resistor 22, the piezoelectric element 32 is fixed directly or indirectly to the surface of the object 90 using, for example, an adhesive, and the piezoelectric element 32 itself also deforms along with the deformation of the object 90. The piezoelectric element 32 includes a piezoelectric body and electrodes holding the piezoelectric body. An electric change (a change in voltage due to surface electric charge) due to a piezoelectric effect caused together with the deformation of the piezoelectric element 32 (piezoelectric body) is transferred to the detection operation unit 40 via the circuit 76 connected to the electrodes of the piezoelectric element 32.

A material constituting the piezoelectric body of the piezoelectric element 32 is not particularly limited as long as it exhibits a piezoelectric effect. For example, barium titanate (BaTiO₃) and lead zirconate titanate (Pb[Zrₓ₋₁Ti₁₋ₓ]O₃) having a perovskite structure, quartz (SiO₂), zinc oxide (ZnO), and so on may be used.

Similar to the resistor 22, the piezoelectric element 32 only needs to be fixed in a way that it can deform along with the deformation of the object 90, and other members such as a substrate, an adhesive layer, etc., may be placed between the piezoelectric element 32 and the object 90. The same applies to the other embodiments as well.

As shown in FIG. 1, the detection operation unit 40 includes a resistance detection unit 42, a piezoelectric detection unit 44, and strain calculation unit 52, which may each include circuitry to perform their corresponding functions as explained in detail below. The detection operation unit 40 may also be configured, for example, by circuitry such as a microprocessor that carries out operations using output from the resistor 22 and the piezoelectric element 32. The detection operation unit 40 is separate from the resistor 22 and the piezoelectric element 32, and it is not directly fixed to the object 90. Note that detection operation unit 40 may be formed integrally with the resistance detection unit 42 and the piezoelectric detection unit 44, and it may be provided on the object 90. Also, the detection operation unit 40 may also be configured using an analog circuit as one of ordinary skill would recognize. The same applies to the other embodiments as well.

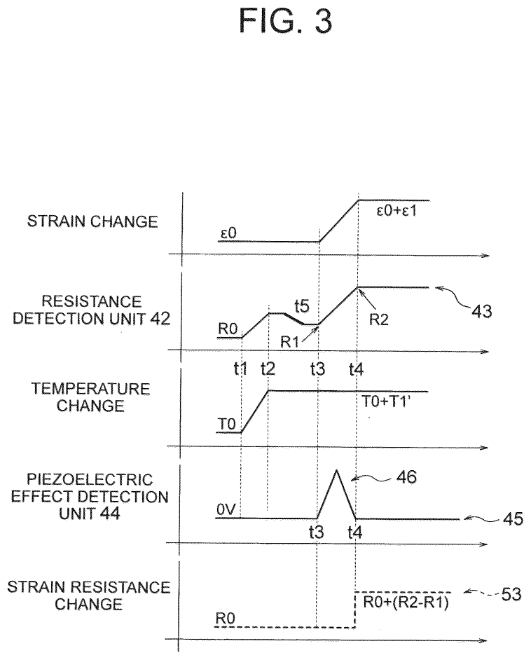

The resistance detection unit 42 detects a change in resistance 43 of the resistor 22 (see FIG. 3). As described in below, the resistance 43 of the resistor 22 changes depending on the degree of strain of the resistor 22, and also changes depending on the temperature of the resistor 22. The detection result of resistance of the resistor 22 detected using the resistance detection unit 42 is passed to the strain calculation unit 52. The resistance detection unit 42 is not limited to those directly detecting the resistance of the resistor 22, and it may also be those detecting the change in resistance of the resistor 22 using voltage and current of the circuit.

The piezoelectric effect detection unit 44 detects a piezoelectric effect of the piezoelectric element 32. For example, as shown in FIG. 3, the piezoelectric effect detection unit 44 detects the piezoelectric effect of the piezoelectric element 32 using an electrical potential difference change 45 generated between the piezoelectric element 32 and the electrodes. The detection result of the piezoelectric effect detected by the piezoelectric effect detection unit 44 is passed to the strain calculation unit 52 as similar to the change in resistance 43 of the resistor 22 detected by the resistance detection unit 42.

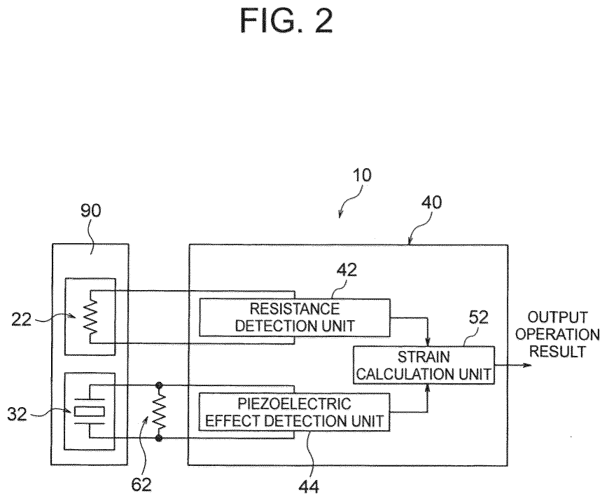

FIG. 2 is a conceptual diagram showing a gist of a circuit and signal processing of the strain measuring system 10 shown in FIG. 1. As shown in FIG. 2, between the piezoelectric effect detection unit 44 and the piezoelectric element 32, a load resistor 62 is connected in parallel to the piezoelectric element 32.

The power consumption of the detection unit for the piezoelectric effect is not particularly limited, and for example, the power consumption of the detection unit for the piezoelectric effect is preferably lower than the power consumption of the detection circuit of the resistance 43 including the resistance detection unit 42 and the resistor 22; and further preferably it is lower than the power consumption of the detection circuit of the resistance 43 by 1/10 or lower.

The strain calculation unit 52 shown in FIG. 1 and FIG. 2 detects the strain changing time 46 which is a time when the change in strain is happening to the object 90 using the detection result of the piezoelectric effect detection unit 44. Further, the strain calculation unit 52 calculates the change in resistance 43 of the resistor 22 occurring during the strain changing time 46 (see R2−R1 of FIG. 3). Further, the strain calculation unit 52 calculates the degree of strain of the object 90 using the calculation results of and the change in resistance 43 (R2−R1). Also, the strain measuring system 10 can export the information regarding the degree of strain of the object 90 which is the operation result of the strain calculation unit 52.

FIG. 3 is a conceptual diagram explaining a first example of signal processing by the strain measuring system 10 shown in FIG. 1 and FIG. 2. A graph shown in FIG. 3 shows, from top to bottom, a strain change of the object 90, the resistance 43 which is the detection result from the resistance detection unit 42, a temperature change of the object 90, a change in electric potential 45 of the piezoelectric element 32 detected by the piezoelectric effect detection unit 44, and a strain resistance change 53 calculated by the strain calculation unit 52. Note that, in FIG. 3, the strain change of object 90 and the temperature change of the object 90 are controlled values or theoretical values; however, on the other hand, the resistance 43, the change in electric potential difference 45 of the piezoelectric element 32, and the strain resistance change 53 are detected values or calculated values obtained using the strain measuring system 10. The same applies to the other embodiments.

As can be understood by comparing strain change, a change in resistance detected by the resistance detection unit 42, and the temperature change shown in FIG. 3, the change in resistance 43 occurs not only by the strain change of the object 90 (the change in resistance can be observed between the time t3 and the time t4) but also by the temperature change of the object 90 (the change in resistance can be observed between the time t1 and the time t2). Also, the resistance 43 detected by the resistance detection unit 42 changes depending on factors other than physical quantities of the object 90 such as self-heating, deterioration over time, and so on (such change can be observed around the time t5.

For the strain measuring system 10, in order to accurately calculate the degree of strain of the object 90, among the change in resistance 43 detected by the resistance detection unit 42, it is necessary to remove the change in resistance 43 which is not caused by strain of the object 90. Thus, using the detection result of the piezoelectric effect detection unit 44, the strain calculation unit 52 of the strain measuring system 10 detects from the detection results of the strain changing time 46 which is a period of time when strain of the object 90 is changing. In the example shown in FIG. 3, a time range between the time t3 which is the starting point that the electric potential of the piezoelectric element 32 starts to change and the time t4 which is the end point of the change in the electrical potential of the piezoelectric element 32 is detected by the strain calculation unit 52 as the strain changing time 46.

Next, the strain calculation unit 52 calculates the change in resistance 43 of the resistor 22 during the strain changing time 46 using the output of the resistance detection unit 42. In the example shown in FIG. 3, the difference between R2 and R1 (R2−R1) is calculated by the strain calculation unit 52 as the change in resistance 43 of the resistor 22 during the strain changing time 46, in which R2 is the resistance 43 at the time t4 that is the end point of the strain changing time 46 and R1 is the resistance 43 at the time t3 that is the starting point of the straining changing time 46.

As such, the strain calculation unit 52 of the strain measuring system 10 can accurately calculate the degree of strain of the object 90 by removing the change in resistance 43 which is not derived from strain of the object 90 from the change in the resistances 43 detected by the resistance detection unit 42. That is, as shown in FIG. 3, in the strain calculation unit 10, the change in resistance detected by the detection of the piezoelectric effect during other than strain changing time 46 (such as the change in the resistance observed between the time t1 and the time t2, and at time t5) is not included in the calculation for the degree of strain of the object 90.

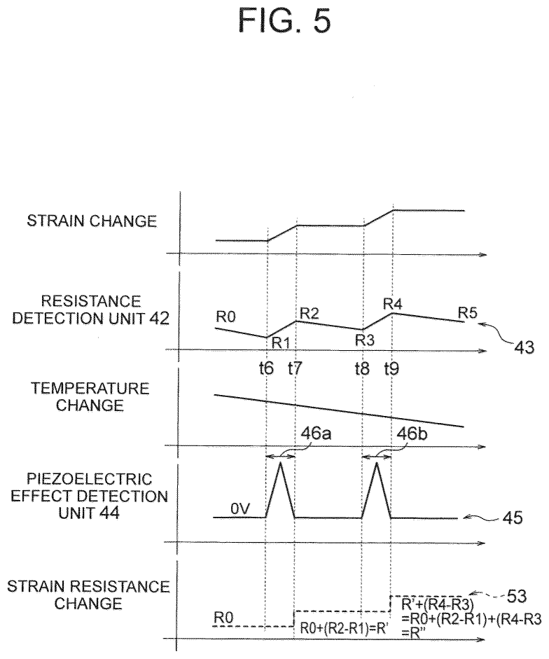

In FIG. 3, the detection of strain using the strain measuring system 10 is explained using a simple example. However, the strain measuring system 10 can carry out complicated and long period of strain detection. FIG. 5 is a conceptual diagram showing a second example of signal processing using the strain measuring system 10 shown in FIG. 1 and FIG. 2.

Similar to FIG. 3, FIG. 5 shows, from top to bottom, a strain change of the object 90, the resistance 43 which is the detection result by the resistance detection unit 42, a temperature change of the object 90, a change in electric potential 45 of the piezoelectric element 32 detected by the piezoelectric effect detection unit 44, and a strain resistance change 53 calculated by the strain calculation unit 52.

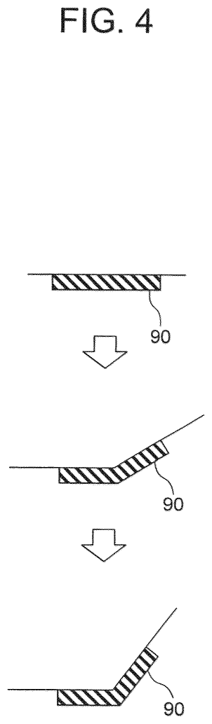

The example shown in FIG. 5 is an example assuming that two step deformations shown in FIG. 4 have occurred to the object 90. That is, the first deformation (shown in the second figure from the top of FIG. 4) occurs between the time t6 and the time t7 (a strain changing time 46a) shown in FIG. 5, and the second deformation (the third figure from the top of FIG. 4) occurs between the time t8 and the time t9 (a strain changing time 46b). Also, as it is shown in a graph of temperature change of FIG. 5, the example shown in FIG. 5 assumes that the temperature of the object 90 gradually decreases.

Even in the case that the temperature change occurs to the object 90 between the strain changing time 46a and the strain changing time 46b (between the time t7 and the time t8) as shown in FIG. 5, the strain measuring system 10 shown in FIG. 1 and FIG. 2 can accurately calculate the degree of strain of the object 90. That is, as shown in FIG. 5, using the detection results of the piezoelectric effect detection unit 44, the strain calculation unit 52 of the strain measuring system 10 detects the strain changing times 46a and 46b, which are times that the change in strains of the object 90 occur.

Next, the strain calculation unit 52 uses output of the resistance detection unit 42 to calculate the change in resistance 43 of the resistor 22 during the strain changing times 46a and 46b. In the example shown in FIG. 5, the strain calculation unit 52 calculates R2−R1, as a change in resistance 43 of the resistor 22 during the strain changing time 46a, which is a difference between the resistance 43 (R2) at the time t7 that is the end point of the strain changing time 46a and the resistance 43 (R1) at the time t6 that is the starting point of the strain changing time 46a. Also, at the same time, the strain calculation unit 52 calculates R4−R3, as a change in resistance 43 of the resistor 22 during the strain changing times 46b, which is a difference between the resistance 43 (R3 and R4) of before and after the strain changing time 46b.

Further, the strain calculation unit 52 uses R2−R1 and R4−R3 which are the calculated values of the changes in resistance 43 of the resistor 22 during the strain changing times 46a and 46b to calculate the degree of strain of the object 90. For example, an initial value R0 of the resistance 43 is added to R2−R1 which is the calculated value of the change in resistance 43 during the strain changing time 46a; and the added value is considered as the strain resistance change 53 (R′) which is a change in resistance corresponding to the degree of strain of the object 90 shown in the second figure from the top of FIG. 4. The strain resistance change 53 is multiplied by a constant of proportionality and the obtained value can be considered as a degree of strain of the object 90 shown in the second figure from the top shown in FIG. 4. Similarly, the strain calculation unit 52 calculates a strain resistance change 53 (R″) corresponding to the degree of strain of the object 90 shown in the third figure from the top shown in FIG. 4, and the degree of strain of the object 90 shown in the third figure from the top shown in FIG. 4 can be calculated.

Note that the example shown in FIG. 5 shows that in order to increase the accuracy of the strain measurement, the strain changing times 46a and 46b preferably occur within a short period of time. In other words, a strain rate of the object 90 is preferably 1×10⁻²(s⁻¹) or faster. As such, the strain measuring system 10 according to the first embodiment effectively detects the resistance change caused by the strain of resistor 22; and even in the case that temperature change, a self-heating of the resistor 22, or so is expected to occur, the strain of the object 90 can be measured accurately.

Also, the power consumption at the circuit for detecting the piezoelectric effect of the piezoelectric element 32 used in the strain measuring system 10 can be smaller compared to the power consumption at the resistance detection circuit for temperature correction which is used in a conventional technology. Further, the temperature difference detected by a conventional resistor for temperature detection and the temperature detected by the resistor 22 for strain detection becomes a problem; however, the strain measuring system 10 can avoid such problem.

### Second Embodiment

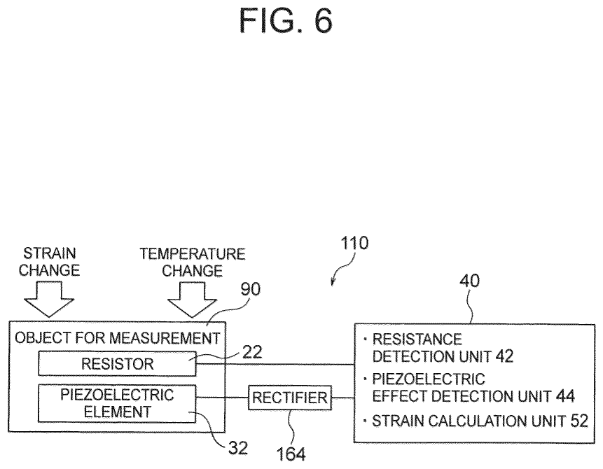

FIG. 6 is a conceptual diagram showing a schematic configuration of a strain measuring system 110 according to the second embodiment. The strain measuring system 110 is basically the same as the strain measuring system 10 shown in FIG. 1 and FIG. 2, except that for the strain measuring system 110, a rectifier 164 is added between the piezoelectric element 32 and the piezoelectric effect detection unit 44. Regarding the strain measuring system 110, differences between the strain measuring system 10 shown in FIG. 1 and FIG. 2 are mainly discussed, and for the common configurations with the strain measuring system 10, the same numerical references are given and explanations of such configurations are omitted.

The rectifier 164 converts electrical signals from the piezoelectric element 32 which include both positive and negative signals into a positive signal only (or a negative signal only) and output to the piezoelectric effect detection unit 44. The rectifier 164 is, for example, configured by a circuit including diode, and a specific configuration of the rectifier 164 is not particularly limited.

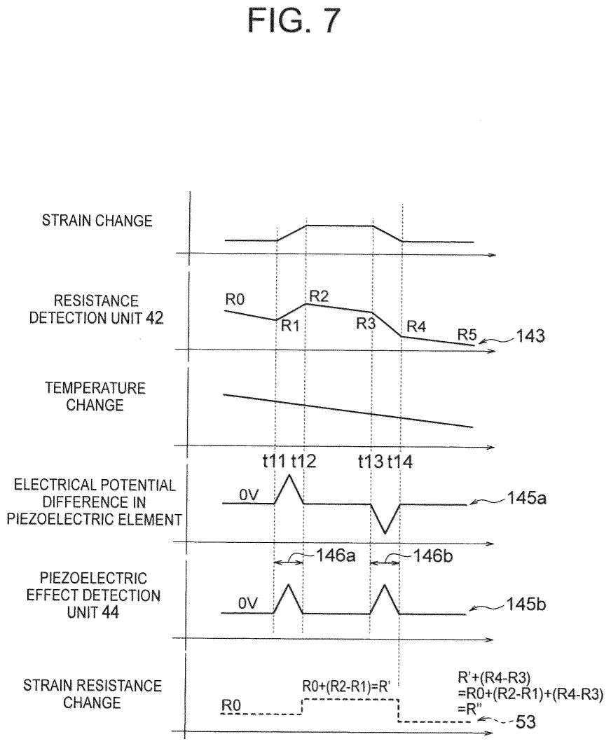

FIG. 7 is a conceptual diagram explaining one example (the third example) of signal processing carried out in the strain measuring system 110 shown in FIG. 6. FIG. 7 shows, from top to bottom, a strain change of the object 90, a resistance 143 which is the detection result detected by the resistance detection unit 42, a temperature change of the object 90, a change in electrical potential difference 145a occurring in the electrodes of the piezoelectric element 32, a change in electrical potential difference 145b detected by the piezoelectric effect detection unit 44, and a strain resistance change 53 detected by the strain calculation unit 52.

Similar to the example 2 shown in FIG. 5, the third example shown in FIG. 7 shows the case assuming that the two step deformations have occurred to the object 90. However, unlike the second example shown in FIG. 5, signs which indicate whether the strain is tensile strain or compression strain is reversed between the first deformation and the second deformation. That is, the first deformation (a strain changing time 146a, tensile strain) occurs between the time t11 and the time t12 shown in FIG. 7, and the second deformation occurs between the time t13 and the time t14 (a strain changing time 146b, compression strain) shown in FIG. 7. Note that, for the temperature change, it is the same as the example shown in FIG. 5.

As can be understood from the fourth graph from the top in the FIG. 7, the change in electrical potential difference 145a detected by the electrodes of the piezoelectric element 32 has opposite signs depending on whether it is a tensile strain or a compression strain. However, in the piezoelectric effect detection unit 44, it is only necessary to have information regarding the starting point and the end point of the strain changing times 146a and 146b during which the object undergoes deformation. Here, in the strain measuring system 110 shown in FIG. 6, the signals from the piezoelectric element 32 are rectified by the rectifier 164, and the signals are transferred to the piezoelectric effect detection unit 44 (the change in electric potential 145b detected by the piezoelectric effect detection unit 44). Thereby, the piezoelectric effect detection unit 44 can receive a simplified form of signal information necessary for calculating the strain changing times 146a and 146b during which the strain of the object 90 changes.

The method for calculating the degree of strain which is carried out by the strain calculation unit 52 of the strain measuring system 110 is similar to the strain calculation unit 52 of the strain measuring system 10. For example, in the example shown in FIG. 7, the calculation result of R2−R1 which is the change in resistance 143 during the strain changing time 146a is added to the initial resistance R0 of the resistance 143, and the added value is considered as the strain resistance change 53 (R′) which is the change in resistance corresponding to the degree of strain of the object 90 after the first deformation. As such, the degree of strain of the object 90 after the first deformation can be calculated. Similarly, the calculation result R2−R1 which is the change in resistance 143 during the strain changing time 146a and the calculation result R4−R3 which is the change in resistance 143 during the strain changing time 146b are added to the initial value R0 of the resistance 143 in the strain calculation unit 52, and the added value is considered as the strain resistance change 53 (R″) which is the change in resistance corresponding to the degree of strain of the object 90 after the second deformation. As such, the degree of strain of the object 90 after the second deformation can be calculated.

In such strain measuring system 110, the signals rectified by the rectifier 164 are input to the piezoelectric effect detection unit 44, hence, the circuit configuration, signal processing, and so on of the piezoelectric effect detection unit 44 and the strain calculation unit 52 in the detection operation unit 40 can be further simplified. Also, regarding the configurations which are the same as the strain measuring system 10, the strain measuring system 110 exhibits the same effects as the strain measuring system 10.

### Third Embodiment

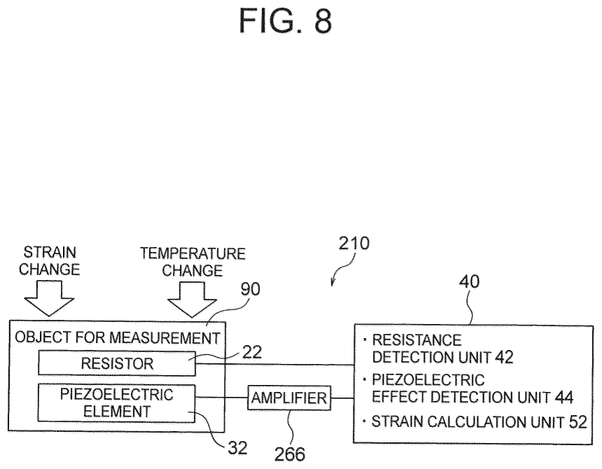

FIG. 8 is a conceptual diagram showing a schematic configuration of a strain measuring system 210 according to the third embodiment. The strain measuring system 210 is basically the same as the strain measuring system 10 shown in FIG. 1 and FIG. 2, except that an amplifier 266 is added between the piezoelectric element 32 and the piezoelectric effect detection unit 44. Regarding the strain measuring system 210, differences between the strain measuring system 10 shown in FIG. 1 and FIG. 2 are mainly discussed, and for the common configurations with the strain measuring system 10, the same numerical references are given, and explanations of such configurations are omitted.

The amplifier 266 amplifies the electrical signals output from the piezoelectric element 32, and the amplified electrical signals are output to the piezoelectric effect detection unit 44. The amplifier 266 is, for example, configured by a voltage amplifier including an operational amplifier and so on, and a specific configuration of the amplifier 266 is not particularly limited.

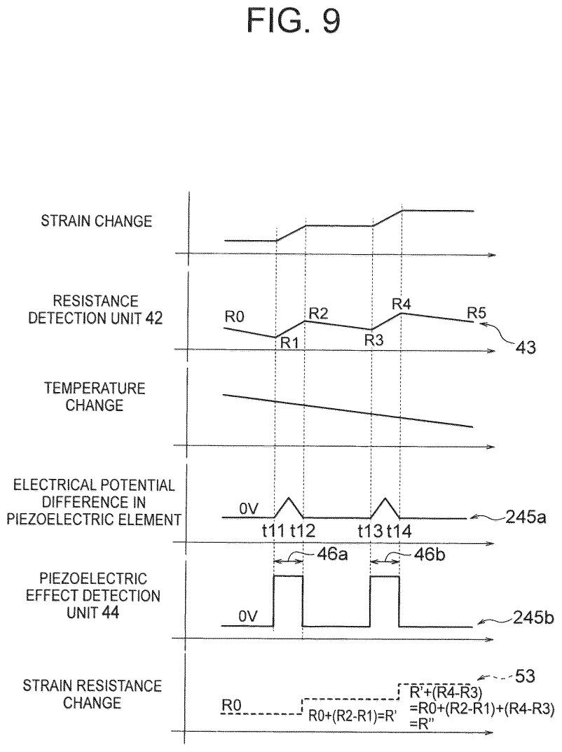

FIG. 9 is a conceptual diagram explaining an example (the fourth example) of signal processing carried out by the strain measuring system 210 shown in FIG. 8. FIG. 9 shows from top to bottom, a strain change of the object 90, the resistance 43 which is the detection result detected by the resistance detection unit 42, a temperature change of the object 90, a change in electrical potential difference 245a occurring in the electrodes of the piezoelectric element 32, a change in electrical potential difference 245b detected by the piezoelectric effect detection unit 44, and a strain resistance change 53 detected by the strain calculation unit 52.

Similar to the example shown in FIG. 5, the example shown in FIG. 9 also shows the case assuming that the two step deformations have occurred to the object 90 while the object 90 undergoes temperature changes.

As can be understood from the fourth graph from the top shown in FIG. 9, the change in electrical potential difference 245a occurring in the electrodes of the piezoelectric element 32 is influenced by the degree of strain of the object 90, the size of the piezoelectric element 32, and so on. For example, when the degree of strain of the object 90 is small, the change in electrical potential difference 245a occurring in the electrodes of the piezoelectric element 32 is small, hence, the detection accuracy of the strain changing time detected by the piezoelectric effect detection unit 44 may decline.

Thus, in the strain measuring system 210 shown in FIG. 8, the amplifier 266 amplifies the change in electrical potential difference 245a occurring in the electrodes of the piezoelectric element 32, and the amplified signal is output to the piezoelectric effect detection unit 44. Thereby, as shown in the fifth graph from the top shown in FIG. 9, the change in electrical potential difference 245b detected by the piezoelectric effect detection unit 44 shows sharp rise and sharp drop, and the detection accuracy of the strain changing times 46a and 46b detected by the piezoelectric effect detection unit 44 can be enhanced.

As shown in FIG. 9, the shapes of sharp signal and sharp drop of signals showing the strain changing times 46a and 46b which are input to the piezoelectric effect detection unit 44 are preferably closer to a square shape compared to the shapes of signals of the change in electrical potential difference 245a occurring in the electrodes of the piezoelectric element 32. Such strain measuring system 210 can enhance the detection accuracy of the strain changing times 46a and 46b, and the strain of the object 90 can be measured accurately.

### Fourth Embodiment

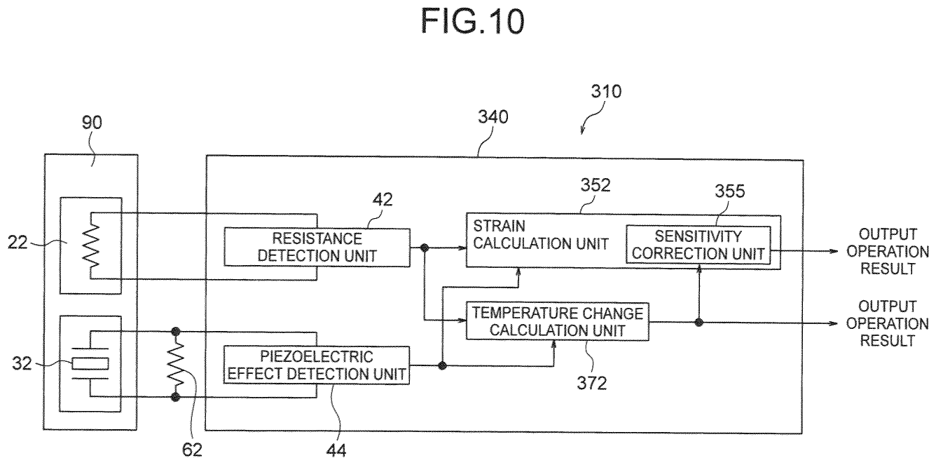

FIG. 10 is a conceptual diagram showing a schematic configuration of a circuit and signal processing of a strain measuring system 310 according to the fourth embodiment. The strain measuring system 310 is basically the same as the strain measuring system 10 shown in FIG. 1 and FIG. 2, except that a detection operation unit 340 of the strain measuring system 310 includes circuitry, such as a temperature change calculation unit 372 and a strain calculation unit 352 of the strain measuring system 310 includes circuitry, such as a sensitivity correction unit 355. Of course, one of ordinary skill will recognize that the temperature change calculation unit 372, the strain calculation unit 352, and the sensitivity correction unit 355 all include circuitry to perform their respective functions as described herein. Regarding the strain measuring system 310, differences between the strain measuring system 10 shown in FIG. 1 and FIG. 2 are mainly discussed, and for the common configurations with the strain measuring system 10, the same numerical references are given, and explanations of such configurations are omitted.

The temperature change calculation unit 372 shown in FIG. 10 detects, using the detection result from the piezoelectric effect detection unit, a strain non-changing time which is a period of time when there is no change in strain of the object 90, calculates the change in resistance of the resistor 22 of the strain non-changing time, and calculates a temperature change of the resistor 22.

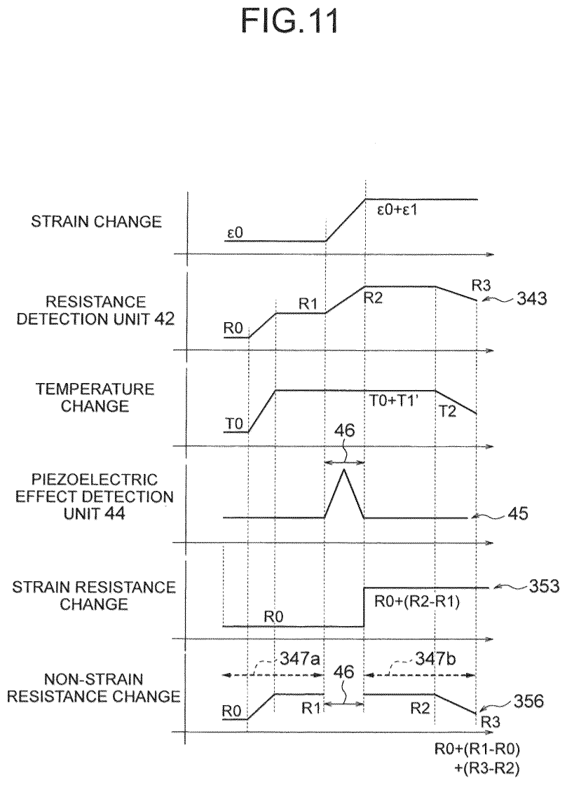

FIG. 11 is a conceptual diagram explaining the fifth example of signal processing carried out by the strain measuring system 310 shown in FIG. 10. Similar to FIG. 3, FIG. 10 shows from top to bottom, a strain change of the object 90, resistance 343 which is the detection result detected by the resistance detection unit 42, a temperature change of the object 90, a change in electrical potential difference 45 of the piezoelectric element 32 detected by the piezoelectric effect detection unit 44, a strain resistance change 353 calculated by the strain calculation unit 352, and a non-strain resistance change 356 calculated by the temperature change calculation unit 372.

Similar to the strain calculation unit 52 shown in FIG. 2, the strain calculation unit 352 of the strain measuring system 310 detects, using the detection results of the piezoelectric effect detection unit 44, the strain changing time 46 which is a period of time when strain of the object 90 changes. Further, similar to the strain calculation unit 52 shown in FIG. 2, the strain calculation unit 352 calculates, using the output value (the resistance 343) of the resistance detection unit 42, the strain resistance change 353 (the fifth graph from the top in FIG. 11) which is a cumulative value of a change in resistance 343 of the resistor 22 during the strain changing time 46. In the example shown in FIG. 11, the strain calculation unit 352 calculates R2−R1 which is the difference between the resistance 343 (R2) at the end point of the strain changing time 46 and the resistance 343 (R1) at the starting point of the strain changing time 46 as the change in resistance 343 of the resistor 22 during the strain changing time 46. Then, the calculated value is added to R0 which is the initial resistance 343 detected by the resistance detection unit 42. As such, the strain calculation unit 352 calculates the strain resistance change 353 which is the change in resistance 343 of the resistor 22 during the strain changing time 46.

The temperature change calculation unit 372 of the strain measuring system 310 detects, using the detection results from the piezoelectric effect detection unit 44, strain non-changing times 347a and 347b which are when there is no change in strain of the object 90. For example, as shown in the fourth graph from the top in FIG. 11, the temperature change calculation unit 372 detects the state where there is no change in electrical potential difference of the electrodes of the piezoelectric element 32 detected by the piezoelectric effect detection unit 44 as the strain non-changing times 347a and 347b. Also, the temperature change calculation unit 372 may detect a period of time other than the strain changing time 46 as the strain non-changing times 347a and 347b.

Further, the temperature change calculation unit 372 calculates the change in resistance 343 of the resistor 22 during the strain non-changing times 347a and 347b using the output from the resistance detection unit 42. In the example shown in FIG. 11, the temperature changing calculation unit 372 calculates R1−R0, which is the difference between the resistance 343 (R1) at the end point of the strain non-changing time 347a and the resistance 343 (R0) at the starting point of the strain non-changing time 347a, as the change in resistance 343 of the resistor 22 during the strain non-changing time 347a. Similarly, the temperature change calculation unit 372 calculates R3−R2 which is the difference between the resistance 343 (R3) at the end point of the strain non-changing time 347b and the resistance 343 (R2) at the start point of the strain non-changing time 347b, and the calculated value is considered as the change in resistance 343 of the resistor 22 during the strain non-changing time 347b. Further, the temperature change calculation unit 372 calculates the non-strain resistance change 356 which is a cumulative value of the change in resistance 343 of the resistor 22 during the strain non-changing times 347a and 347b.

Also, the temperature change calculation unit 372 detects the temperature of the resistor 22 and the temperature of the object 90 to which and the resistor 22 are fixed, using the non-strain resistance change 356 which is the calculation result of the cumulative value of the change in resistance 343 of the resistor 22 during the strain non-changing times 347a and 347b. For example, in the temperature calculation unit 372, the non-strain resistance change 356 is multiplied by the predetermined constant of proportionality and the obtained value is calculated as the temperature of the resistor 22, and then the calculation result can be output to outside.

Also, as shown in FIG. 10, the temperature change calculation unit 372 may output the temperature information of the resistor 22, which is the calculation result, to the strain calculation unit 352. For example, the strain calculation unit 352 includes the sensitivity correction unit 355, and the sensitivity correction unit 355 can correct the constant of proportionality used for calculating the strain based on the temperature information of the resistor 22 input to the strain calculation unit 352. For example, in the strain calculation unit 352 of the strain measuring system 310, the strain resistance change 353 calculated as shown in the fifth graph from the top in FIG. 11 is multiplied by the constant of proportionality which has been temperature corrected in the sensitivity correction unit 355 based on the temperature information of the resistor 22 calculated by the temperature change calculation unit 372. The obtained value is the degree of strain of the object 90.

The strain measuring system 310 shown in FIG. 10 and FIG. 11 includes the temperature change calculation unit 372 detecting the temperatures of the resistors 22 and the object 90 using the detection results of the piezoelectric element 32 and the resistor 22. Such strain measuring system 310 can detect both strain and temperature with smaller power consumption compared to a conventional method of measuring the temperature using a resistor provided separately from the resistor 22 for strain detection. Also, such strain measuring system 310 detects both strain and temperature based on the change in resistance 343 detected by the resistor 22 and the resistance detection unit 42. Hence, for the strain measuring system 310, the measured temperatures do not vary depending on the place of the resistor, which is the case for the conventional technology detecting strain and temperature using separate resistors. Therefore, the strain calculation unit 352 of the strain measuring system 310 can accurately carry out temperature correction while calculating the strain of the object 90.

The strain measuring system 310 exhibits the same effects as the strain measuring system 10 regarding the common configurations with the strain measuring system 10.

### Fifth Embodiment

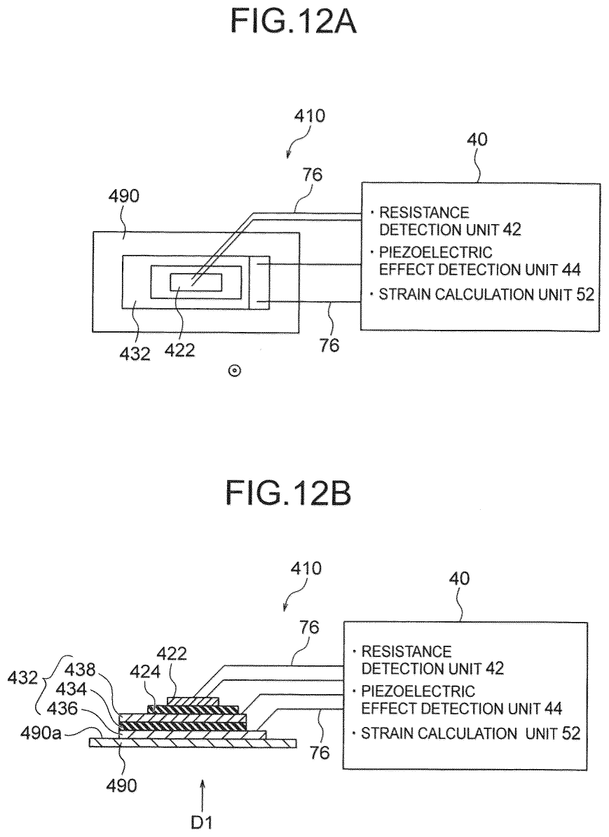

FIG. 12A and FIG. 12B are conceptual diagrams showing schematic configurations of a strain measuring system according to the fifth embodiment. The strain measuring system 410 is basically the same as the strain measuring system 10 shown in FIG. 1 and FIG. 2, except that the arrangements of a resistor 422 and a piezoelectric element 432 with respect to an object to be measured 490 are different. Regarding the strain measuring system 410, differences between the strain measuring system 10 shown in FIG. 1 and FIG. 2 are mainly discussed, and for the common configurations with the strain measuring system 10, the same numerical references are given, and explanations of such configurations are omitted.

FIG. 12A is a plan view of the strain measuring system 410, and FIG. 12B is a cross sectional diagram of the strain measuring system 410. As shown in FIG. 1, in the strain measuring system 10, the resistor 22 and the piezoelectric element 32 are aligned on one plane of the object 90 for strain measurement. This arrangement of the resistor 22 and the piezoelectric element 32 as shown in FIG. 1 is not a problem when the object 90 is strained roughly uniformly. However, when strain of the object 90 differs between the position where the resistor 22 is arranged and the position where the piezoelectric element 32 is arranged, then the error included in the calculated value of strain may increase.

Therefore, in the strain measuring system 410 shown in FIG. 12A and FIG. 12B, the resistor 422, the piezoelectric element 432, and the object 490 are at least partially overlapped with each other along a first direction D1 which is the predetermined direction. That is, as shown in FIG. 12B, in the strain measuring system 410, the piezoelectric element 432 is fixed on one plane 490a of the object 490, and the resistor 422 is fixed on the piezoelectric element 432; thus, the resistor 422, the piezoelectric element 432, and the object 490 are overlapped with each other along the first direction D1.

As shown in FIG. 12B, the piezoelectric element 432 includes a lower electrode 436 fixed on one plane 490a of the object 490, a piezoelectric body 434 stacked on the lower electrode 436, and an upper electrode 438 stacked on the piezoelectric body 434. The piezoelectric body 434 is placed between the lower electrode 436 and the upper electrode 438.

The resistor 422 is fixed on the piezoelectric element 432 via a resistor base part 424. The resistor base part 424 is configured using, for example, a thin insulation layer. A method for fixing the resistor 422, the resistor base part 424, and the piezoelectric element 432 is not particularly limited; and for example, methods such as adhesion, physical suction, chemical suction, welding, and so on may be mentioned.

As shown in FIG. 12A and FIG. 12B, the strain measuring system 410 has a structure that the resistor 422, the piezoelectric element 432, and the object 490 are stacked along the direction D1 which is a stacking direction; thus, the resistor 422 and the piezoelectric element 432 are arranged roughly at the same position of the object 490 in the plan view direction.

Therefore, in the strain measuring system 410, the period of time while the change in resistance 43 of the resistor 422 occurs due to the strain change shown in FIG. 3 can be detected using the piezoelectric element 432 with high accuracy as the strain changing time 46. Thereby, a highly accurate strain measurement can be achieved. Also, even in the case that strain of the object 490 is not uniform, the resistor 422 and the piezoelectric element 432 detect the temperature change and the change in resistance 43 of the same place of the object 490; thus, at such place of the object 490, a highly accurate strain measurement can be achieved.

Also, in the strain measuring system 410, the resistor 422 and the piezoelectric element 432 can be arranged on a small area of the object 490; thus, this is advantageous from the point of achieving compact strain measuring system, and suited for the strain measurement of a small object 490. Further, regarding the same configurations as the strain measuring system 10, the strain measuring system 410 exhibits the same effects.

### Sixth Embodiment

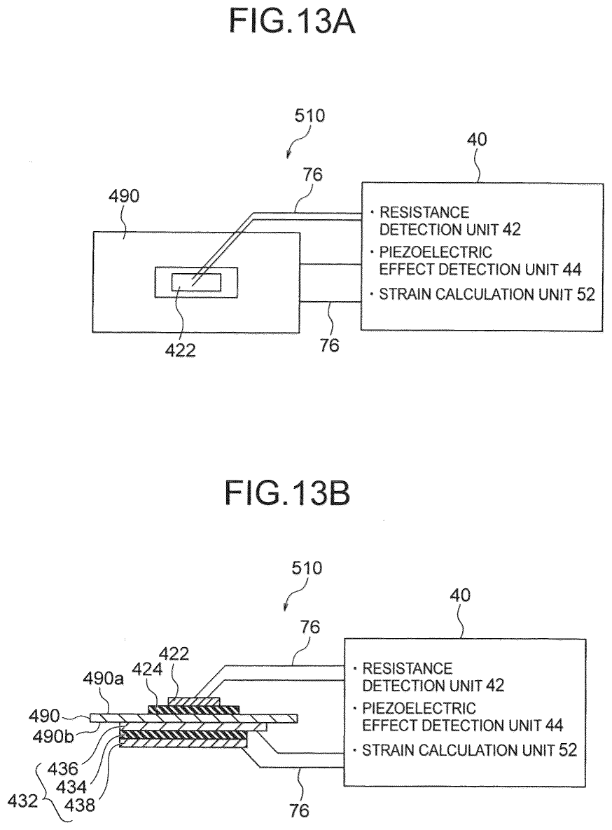

FIG. 13A and FIG. 13B are conceptual diagrams showing the schematic configurations of a strain measuring system 510 according to the sixth embodiment. The strain measuring system 510 is basically the same as the strain measuring system 410 shown in FIG. 12A and FIG. 12B, except that the arrangement of the resistor 422 and the piezoelectric element 432 against the object 490 is different. Regarding the strain measuring system 510, differences between the strain measuring system 410 shown in FIG. 12A and FIG. 12B are mainly discussed, and for the common configurations with the strain measuring system 410, the same numerical references are given, and explanations of such configurations will be omitted.

FIG. 13A is a plan view of the strain measuring system 510, and FIG. 13B is a cross sectional diagram of the strain measuring system 510. As shown in FIG. 13B, in the strain measuring system 510, the resistor 422 is fixed via the resistor base part 424 on one plane 490a of the object 490, and the piezoelectric element 432 is fixed on the other plane 490b which is the opposite plane of the plane 490a of the object 490. Thereby, similar to the strain measuring system 410, in the strain measuring system 510, the resistor 422, the piezoelectric element 432, and the object 490 are stacked along the direction D1 which is a thickness direction. Hence, the resistor 422 and the piezoelectric element 432 are arranged on roughly the same position of the object 490 in the plan direction.

Therefore, similar to the strain measuring system 410, in the strain measuring system 510, the period of time when resistance of the resistor 422 is changing due to a predetermined strain change is accurately detected as the strain changing time 46 using the piezoelectric element 432; thus, a highly accurate strain detection is achieved. Also, in the strain detection system 510, a piezoelectric element 432 is not arranged between the resistor 422 and the object 490, and the resistor 422 is not arranged between the piezoelectric element 432 and the object 490. Thus, deformation stress due to strain of the object 490 and heat of the object 490 are transferred even more directly to the piezoelectric element 490 and the resistor 422. Therefore, in the strain measuring system 510, strain of the object 490 can be detected even more accurately. Also, even in the case of the strain measuring system 510, the resistor 422 and the piezoelectric element 432 detect the change in resistance 43 and the temperature change of the same place of the object 490; thus, at such place of the object 490, a highly accurate strain measurement can be achieved.

Further, for the common configurations with the strain measuring system 410, the strain measuring system 510 exhibits the same effects as the strain measuring system 410.

### Seventh Embodiment

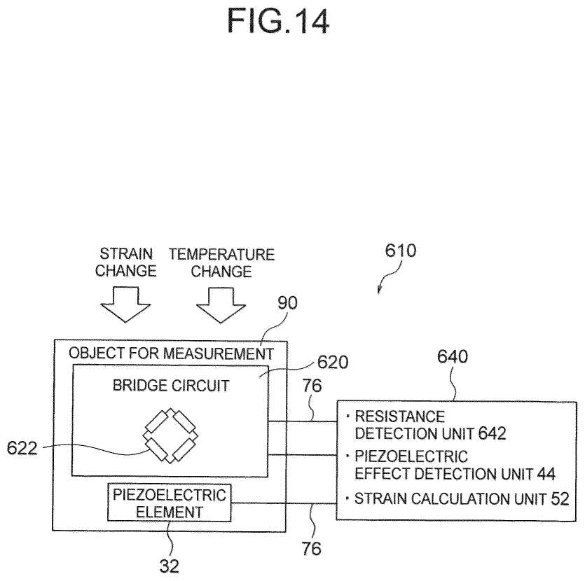

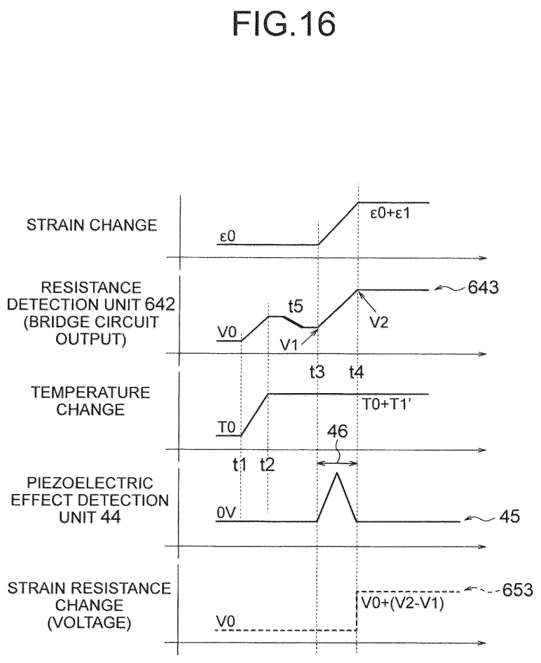

FIG. 14 is a conceptual diagram showing a schematic configuration of a strain measuring system 610 according to the seventh embodiment. As shown in FIG. 14, the strain measuring system 610 differs from the strain measuring system 10 shown in FIG. 1 that the strain measuring system 610 includes a bridge circuit 620 including a resistor 622, and a resistance detection unit 642, which includes circuitry, detects the change in resistance of the resistor 622 by measuring the output of the bridge circuit 620 (see voltage 643 of FIG. 16). However, the strain measuring system 610 shown in FIG. 14 is basically the same as the strain measuring system 10 shown in FIG. 1, except that the configurations of the bridge circuit 620 and the resistance detection unit 642 of the strain measuring system 610 differ from those of strain measuring system 10. Regarding the strain measuring system 610, differences between the strain measuring system 10 shown in FIG. 1 are mainly discussed, and for the common configurations with the strain measuring system 10, the same numerical references are given, and explanations of such configurations are omitted.

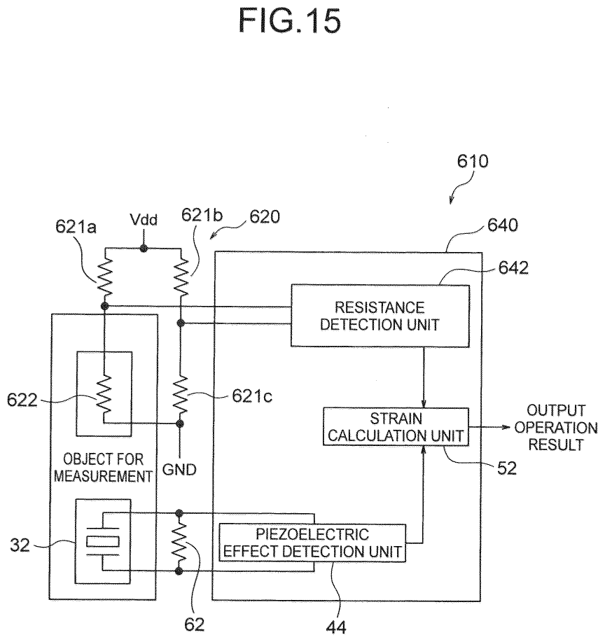

FIG. 15 is a conceptual diagram showing a schematic configuration of a circuit and signal processing of the strain measuring system 610 shown in FIG. 14. As shown in FIG. 15, in addition to the resistor 622 provided on the object 90, the bridge circuit 620 includes bridge resistors 621a, 621b, and 621c which are other resistors configuring the bridge circuit 620; and the resistor 622 and the bridge resistors 621a, 621b, and 621c configure a Wheatstone bridge. Similar to the resistor 22 shown in FIG. 2, the resistor 622 also deforms along with the deformation of the object 90, and the resistance changes in accordance with the deformation. Materials, methods, and so on for producing the resistor 622 are the same as the resistor 22 shown in FIG. 2.

The bridge resistances 621a, 621b, and 621c shown in FIG. 15 are different from the resistor 622, and these do not generate the change in resistance depending on the shape of the object 90. Power voltage Vdd is applied from a power supplying unit, or power supply circuit, not shown in the figure, to the bridge circuit 620. The output of the bridge circuit 620 is passed to the resistance detection unit 642 of the detection operation unit 640. The resistance detection unit 642 detects the change in resistance of the resistor 622 by measuring the voltage 643 (see FIG. 16) which is the output of the bridge circuit 620. Note that, regarding the bridge circuit 620 shown in FIG. 15, only the resistor 622 which is one of the resistors configuring the bridge circuit 620 generates the change in resistance along with the deformation of the object 90. However, the bridge circuit 620 is not limited to this, and it may have a plurality of resistors which generates the change in resistance along with the deformation of the object 90.

FIG. 16 is a conceptual diagram explaining the sixth example of signal processing of the strain measuring system 610 shown in FIG. 14 and FIG. 15. FIG. 16 shows from top to bottom, a strain change of the object 90, the voltage 643 which is the output of the bridge circuit 620 detected by the resistance detection unit 642, a temperature change of the object 90, a change in electrical potential difference 45 of the electrodes of the piezoelectric element 32 detected by the piezoelectric effect detection unit 44, and a strain resistance change 653 which is calculated by the strain calculation unit 52. Note that, in FIG. 16, the strain change of the object 90 and the temperature change of the object 90 are controlled values or theoretical values, and the voltage 643 of the bridge circuit, the change in electrical potential difference 45 of the piezoelectric element 32, and the strain resistance change 653 are the detected values or the calculated values obtained in the strain measuring system 610.

As shown in FIG. 16, in the strain calculation unit 52 of the strain measuring system 610, the strain changing time 46, which is a period of time when strain of the object 90 changes, is detected using the detection result of the piezoelectric effect detection unit 44. Next, using the detection result of the resistance detection unit 642, the strain calculation unit 52 calculates the change in resistance of the resistor 622 which appears as the output of the bridge circuit 620 during the strain changing time 46. In the example shown in FIG. 16, the strain calculation unit 52 calculates V2−V1, which is the difference between the detected value of the resistance detection unit 642 at the time t4 that is the end point of the strain changing time 46 and the detected value of the resistance detection unit 642 at the time t3 that is the starting point of the strain changing time 46, as the information corresponding to the change in resistance (strain resistance change 653) of the resistor 22 during the strain changing time 46.

Further, the strain calculation unit 52 calculates the degree of strain of the object 90 using V2−V1 which is the change in output of the bridge circuit 620 corresponding to the change in resistance of the resistor 22. For example, in the strain calculation unit 52, the initial output V0 of the bridge circuit 620 is added to V2−V1 which is the calculated value of the change in output 643 during the strain changing time 46, and the added value is considered as the information corresponding to the degree of strain of the object 90 at the time t4. The strain resistance change 653 is multiplied by the predetermined constant of proportionality, thereby the degree of strain of the object 90 at the time t4 can be obtained.

Such strain measuring system 610 detects the change in resistance of the resistor 622 using the bridge circuit 620, and together with the detection result of the strain changing time 46 using the piezoelectric element 32, a highly sensitive and a highly accurate strain detection can be achieved. Furthermore, for the common configurations with the strain measuring system 10, the strain measuring system 610 exhibits the same effects as those of the strain measuring system 10.

### Eighth Embodiment

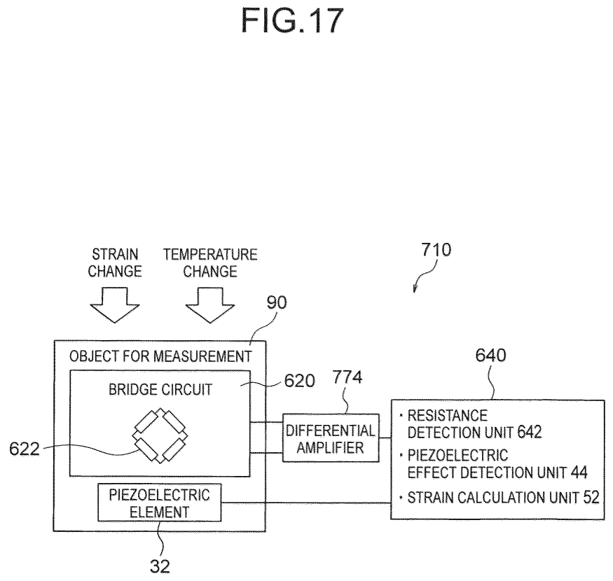

FIG. 17 is a conceptual diagram showing schematic configurations of the strain measuring system 710 according to the eighth embodiment. As shown in FIG. 17, the strain measuring system 710 is basically the same as the strain measuring system 610 shown in FIG. 14, except that the strain measuring system 710 has a differential amplifier 774 arranged between the resistance detection unit 642 and the bridge circuit 620 including the resistor 622. Regarding the strain measuring system 710, differences between the strain measuring system 610 shown in FIG. 14 and FIG. 15 are mainly discussed, and for the common configurations with the strain measuring system 610, the same numerical references are given, and explanations of such configurations are omitted.

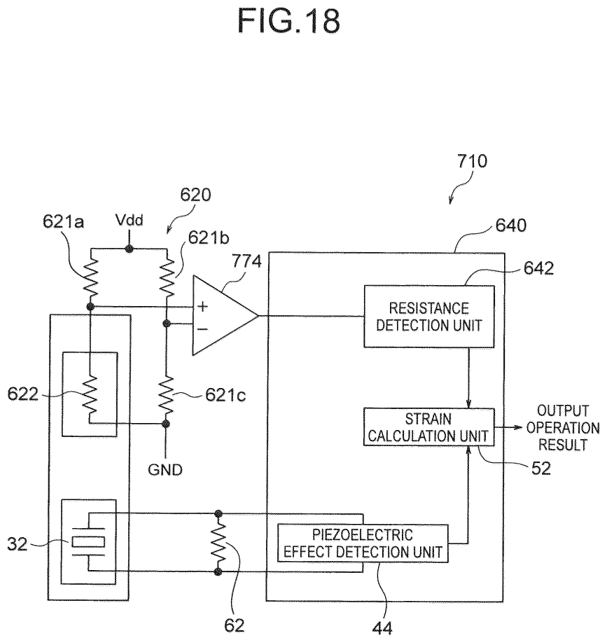

FIG. 18 is a conceptual diagram showing a schematic configuration of a circuit and signal processing of strain measuring system 710 shown in FIG. 17. As shown in FIG. 18, the strain measuring system 710 includes the differential amplifier 774 which amplifies the output of the bridge circuit 620. The resistance detection unit 642 detects the change in resistance of the resistor 622 by measuring the output of the bridge circuit which has been amplified by the differential amplifier 774. Regarding the bridge circuit 620, the resistance detection unit 642, the strain calculation unit 52, and so on included in the strain measuring system 710, these are the same as the bridge circuit 620, the resistance detection unit 642, the strain calculation unit 52, and so on included in the strain measuring system 610 shown in FIG. 14 and FIG. 15.

The differential amplifier 774 amplifies the output of the bridge circuit 620 which detects the change in resistance of the resistor 622 and passes the amplified output to the resistance detection unit 642; thus, a highly sensitive and a highly accurate strain detection can be achieved. Regarding the conventional circuit which amplifies the output of the bridge circuit 620 by the differential amplifier 774, there is a risk that error may occur due to drift of the differential amplifier 774 during the calculation of strain using the strain calculation unit 52. However, the strain measuring system 710 uses the bridge circuit 620 and the differential amplifier 774 together with the detection result of the strain changing time 46 using the piezoelectric element 32; thereby, it is possible to exclude the influence of drift of the differential amplifier 774 occurring at the period of time other than the strain changing time 46.

Besides this, regarding the common configurations between the strain measuring system 710 and the strain measuring system 610, the strain measuring system 710 exhibits the same effects as the strain measuring system 610.

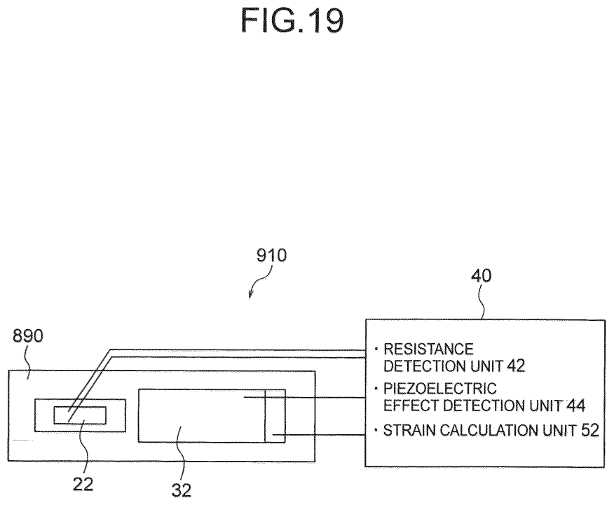

Hereinabove, the strain measuring system according to the present disclosure was described using the embodiments. However, the technical scope of the strain measuring system according to the present disclosure is not limited to the above-mentioned embodiments, and many other embodiments and modification examples are included. For example, the arrangement of the resistor 22 and the piezoelectric element 32 with respect to the object 90 is not limited to the arrangement described in the above-mentioned embodiments; and as in the case of a strain measuring system 810 according to the modification examples shown in FIG. 19, the direction of arrangement of the resistor 22 and the piezoelectric element 32 may match a longitudinal direction of the resistor 22 and the piezoelectric element 32. A longitudinal direction of the resistor 22 and a longitudinal direction of the piezoelectric element 32 may align with a longitudinal direction of the object 90, or may not align therewith. A central axis of the resistor 22 along the longitudinal direction of the resistor 22, a central axis of the piezoelectric element 32 along the longitudinal direction of the piezoelectric element 32, and a central axis of the object 90 along the longitudinal direction of the object 90 may overlap, or may not overlap.

Also, regarding the configurations of the circuit and the control block for achieving the strain measuring system, those shown in FIG. 2, FIG. 10, FIG. 15, FIG. 18, and so on are simply examples, and various modifications, additions, removals, and so on may be carried out to the circuit configurations shown in the examples without departing from the scope of the present disclosure. The strain measuring system achieved using such circuits is also included in the technical scope of the strain measuring system according to the present disclosure.

As can be understood from the above, the present specification discloses the below.

### Supplementary note 1

A strain measuring system, comprising:
a piezoelectric element and a resistor provided on an object;
a resistance detection circuit configured to detect a change in resistance of the resistor;
a piezoelectric effect detection circuit configured to detect a piezoelectric effect of the piezoelectric element; and
a strain calculation circuit configured to detect a strain changing time while the strain of the object is changing using a detection result from the piezoelectric effect detection circuit, calculate a change in resistance of the resistor during the strain changing time, and calculate a degree of strain of the object using a calculation result of the change in resistance.

Such strain measuring system detects the strain changing time by detecting the piezoelectric effect of the piezoelectric element, and calculates the change in resistance of the resistor during the strain changing time; thus, unless the strain rate is extremely slow than expected, the resistance change of the resistor can be effectively detected. Also, the power consumption for detecting the piezoelectric effect of the piezoelectric element is smaller than the power consumption for detecting the resistance of the resistor, thus such strain measuring system can reduce the power consumption.

### Supplementary note 2

The strain measuring system according to the present disclosure further comprises a temperature change calculation circuit configured to calculate a strain non-changing time which is a period of time when no change occurs in the strain of the object using the detection result from the piezoelectric effect detection circuit, calculate a change in the resistance of the resistor during the strain non-changing time, and calculate a temperature change of the resistor.

Such strain measuring system can detect a change in the environmental temperature. Also, using the detected value of the calculated temperature change, it is possible to accurately carry out sensitivity correction between the change in resistance and strain. Hence, strain can be accurately measured in a wide temperature range. Also, since the strain non-changing time is detected using the detection result of the piezoelectric effect detection circuit, such strain measuring system can reduce the power consumption compared to those detecting the temperature using the change in resistance.

### Supplementary Note 3

The resistor, the piezoelectric element, and the object are at least partially overlapped with each other along a predetermined direction.

In such strain detection system, the resistor and the piezoelectric element can be arranged close to each other; thus, this can effectively prevent the problem that the detection result of the strain changing time from the piezoelectric element not accurately matching the time when strain is actually changing in the resistor. Also, such strain measuring system is advantageous from the point of achieving compact device.

### Supplementary Note 4

The strain measuring system according to the present disclosure further comprises a bridge circuit including the resistor; and the resistance detection circuit detects the change in resistance of the resistor by measuring output of the bridge circuit.

Such strain measuring system achieves a highly sensitive and a highly accurate strain detection.

### Supplementary Note 5

The strain measuring system according to the present disclosure further comprises a bridge circuit including the resistor and an amplifier amplifying an output of the bridge circuit; and the resistance detection unit detects the change in resistance of the resistor by measuring the output of the bridge circuit amplified by the amplifier.

Such strain measuring system achieves a highly sensitive and a highly accurate strain detection. Also, the strain calculation unit calculates the degree of strain of the object by using the change in resistance of the resistor during the strain changing time; thus, it is unlikely to be influenced by drift of an amplifier. Therefore, a highly accurate strain measurement is possible.

### Circuit Example

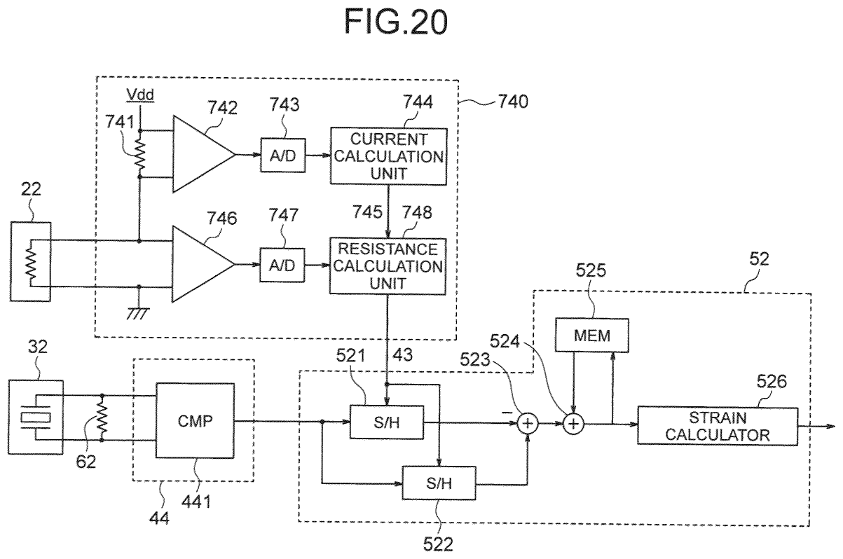

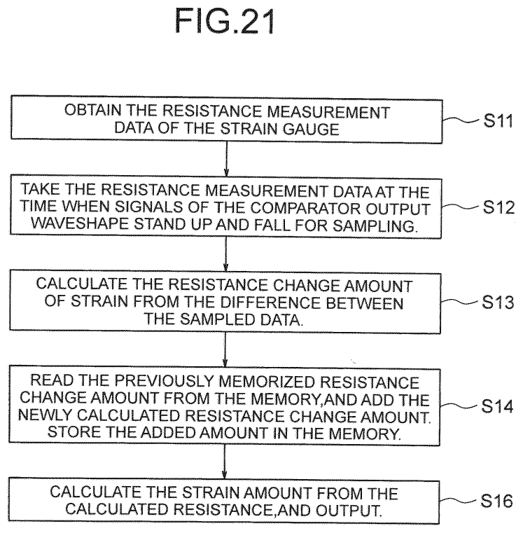

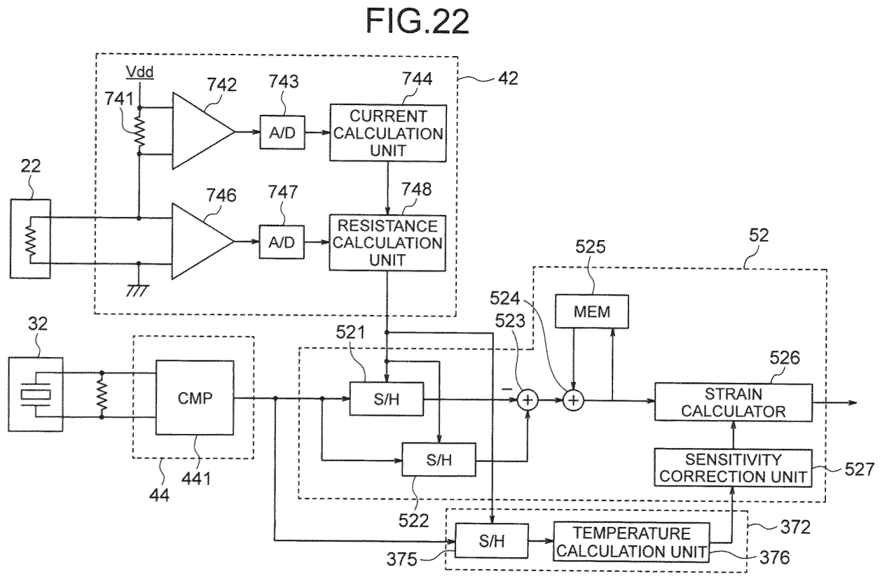

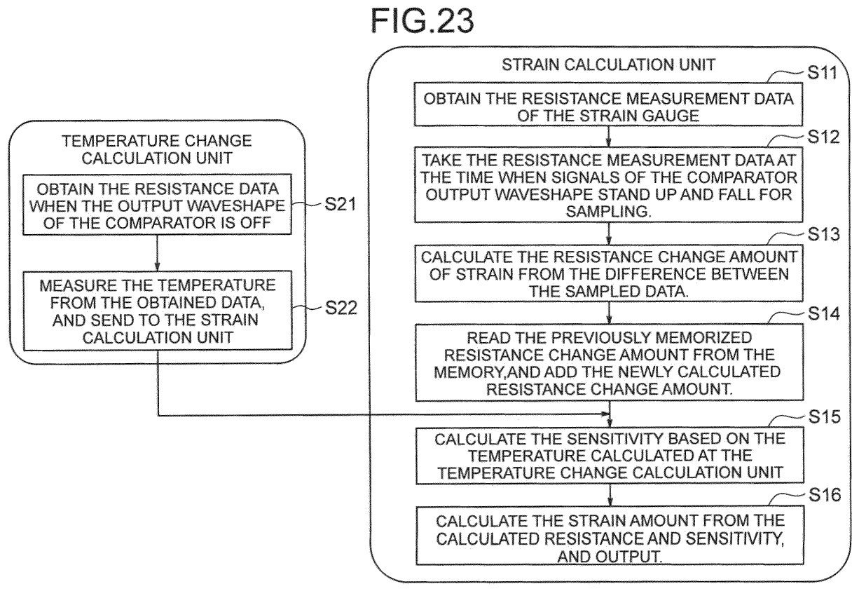

The strain measuring system according to the present disclosure can be realized by using circuits shown in FIG. 20 and FIG. 22, or by using computer processing based on flowcharts shown in FIG. 21 and FIG. 23.

FIG. 20 shows an example of a circuit realizing the resistance detection unit, the piezoelectric effect detection unit, and the strain calculation unit according to the present disclosure.

Regarding the circuit shown in FIG. 20, in a resistance detection unit 740 includes circuitry in which a voltage decline in a shunt resistor 741 connected in series with the resistor 22 is detected and amplified, the amplified signal by an operational amplifier 742 is converted into a digital signal by an Analog-to-Digital (AD) convertor 743, and the converted digital signal is used for a predetermined operation in a current calculation unit 744 that includes circuitry to calculate a signal representing a current. Then, the signal representing the current is output to a resistance calculation unit 748. Also, voltage at both sides of the resistor 22 is detected and amplified using an operational amplifier 746, and the amplified signal is converted into a digital signal using an AD convertor 747. Then, the converted digital signal is output to the resistance calculation unit 748. Further, the resistance calculation unit includes circuitry with which the resistance 43 of the resistor 22 is calculated based on the signal from the current calculation unit 744 representing the current in the resistor 22, and based on the signal from the AD convertor 747 representing voltage at both ends of the resistor 22.

Note that, the current calculation unit 744 may be realized by using a microcomputer, by using a logic circuit which uses memory in ROM corresponding to an output signal from the AD convertor 743 and the signal representing current, or by using an operation resource of other computers and logic circuits included in the strain measuring system of the present disclosure.

Also, the resistance calculation unit 748 may be realized by using a microcomputer, or by using an operation resource of other computers and logic circuits included in the strain measuring system of the present disclosure may be used.

In the circuit shown in FIG. 20, the piezoelectric effect detection unit 44 includes a comparator 441. The piezoelectric effect detection unit 44 is connected to the piezoelectric element 32 via the load resistor 62 connected in parallel. The signal showing electrical potential difference between the electrodes of the piezoelectric element 32 is input to the comparator 441 and compared to a standard voltage, and the signal is converted into a square wave. In the signal converted into a square wave, a rising edge part shows that the object is strained, and a falling edge part shows that strain of object is released. The piezoelectric effect detection unit 44 outputs this square signal to the strain calculation unit 52.

Note that, if sample hold circuits 521 and 522 allow, the piezoelectric effect detection unit 44 does not have to convert the signal representing the electrical potential difference between the electrodes of the piezoelectric element 32 into a square wave, and the signal representing the electrical potential difference may be simply shaped into a waveform, and the waveform-shaped signal may be output to the strain calculation unit 52 as a sampling trigger signal.

Regarding the circuit shown in FIG. 20, the strain calculation unit 52 includes circuitry in which a first sample hold circuit 521 holds a signal which has been input from the resistance calculation unit 748 of the resistance detection unit 740 at the rising edge part of the signal input from the comparator 441 of the piezoelectric effect detection unit 44. That is, the first sample hold circuit 521 holds the resistance 43 of the resistor 22 at the point when the electrical potential difference signal between the electrodes of the piezoelectric element 32 stands up. Also, a second sample hold circuit 522 holds a signal which has been input from the resistance calculation unit 748 of the resistance detection unit 740 at the time of the falling edge part of the signal input from the comparator 441 of the piezoelectric effect detection unit 44. That is, the second sample hold circuit 522 holds the resistance 43 of the resistor 22 at the point when the electrical potential difference signal between the electrodes of the piezoelectric element 32 falls. Then, a difference between the signal held by the second sample hold circuit 522 and the signal held by the first sample hold circuit 521 is detected by an adder circuit (accumulator) 523, thereby an amount of change in resistance of the resistor 22 is calculated.

The amount of change in resistance of the resistor 22 calculated by the accumulator 523 is added by an adder circuit (accumulator) 524 to a resistance change amount (a cumulative resistance change amount) up until it is read from a memory 525; thereby, the cumulative resistance change amount within a measuring period is obtained as a cumulative result. The obtained cumulative resistance change is stored in the memory 525 as an updated cumulative resistance change amount. Then, based on this cumulative resistance change amount, the amount of strain showing the degree of strain of the object is calculated in a strain calculator 526, and the calculated amount of strain is output to outside.

Note that, the strain calculator 526 may be realized by using a microcomputer, or by using an operation resource of other computers and logic circuits included in the strain measuring system of the present disclosure.

Also, the overall processing in the strain calculation unit 52 may be realized using circuits such as a microcomputer or a processing unit (PU). In such case, the processing may be carried out as shown in the flowchart of FIG. 21.

That is, first, the strain calculation unit 52 obtains (temporarily memorize) the resistance measurement data 43 of the resistor 22 which has been input from the resistance detection unit 740 (a step S11). Next, based on the signals representing the electrical potential difference between the electrodes of the piezoelectric element 32 which has been input from the comparator 441 of the piezoelectric effect detection unit 44, the strain calculation unit 52 takes the resistance measurement data 43 (R1 and R2) for sampling (i.e., memorize in a readable manner) at the time when the signals stand up and falls (a step S12). Next, the strain calculation unit 52 calculates a difference (the resistance change amount due to strain of the resistor 22) between the sampled resistance measurement data (R1) at the time when the signal stands up and the sampled resistance measurement data (R2) at the time when the signal falls (a step S13). Next, the previously memorized resistance change amount (the cumulative resistance change amount) is read from the memory, and the newly calculated resistance change amount of the difference (the resistance change amount due to strain of the resistor 22) is added to the resistance change amount which has been read out, and the added resistance change amount is memorized in the memory as an updated cumulative resistance change amount (a step S14). Then, once a predetermined measuring period is completed and when requested from outside, or per predetermined period of time, the strain amount is calculated and output (a step S16) based on the new resistance change amount calculated at the step S13, the cumulative resistance change amount calculated and updated at the step S14, or the desired resistance change amount (cumulative resistance change amount) memorized in the memory.

FIG. 22 shows another example of circuit used in the strain measuring system according to the present disclosure; and it is a figure showing an example of circuit realizing the resistance detection unit, the piezoelectric effect detection unit, the strain calculation unit, and the temperature change calculation unit.

The circuit shown in FIG. 22 is basically the same as the circuit 20, except that a temperature change calculation unit 372 and a sensitivity correction unit 527 are added to the circuit shown in FIG. 22.

That is, the temperature change calculation unit 372 shown in FIG. 22 includes circuitry in which when the signal which has been input from the comparator 441 of the piezoelectric effect detection unit 44 is at low level, the sample holding circuit 375 holds the input signal from the resistance calculation unit 748 of the resistance detection unit 740. That is, the sample hold circuit 375 holds the resistance of the resistor 22 when the object is not strained (during the strain non-changing time). Next, based on the resistance of the resistor 22 when the object is not strained (during the strain non-changing time), the temperature calculation unit 376 calculates the temperature of the resistor 22 (or the temperature of the object where the resistor 22 is fixed), and the calculated temperature is output to the sensitivity correction unit 527 of the strain calculation unit 52. For example, in the temperature calculation unit 376, the resistance of the resistor 22 or the change in resistance may be multiplied by the predetermined constant of proportionality, and the calculated value may be considered as the temperature of the resistor 22 and so on. In the sensitivity correction unit 527 of the strain calculation unit 52, the constant of proportionality used for calculating the strain is corrected based on the input temperature information of resistor 22, and the corrected constant of proportionality is output to the strain calculator 526. In the strain calculator 526, using the corrected constant of proportionality, the strain amount is calculated based on the input accumulated resistance change amount.

Processing carried out in the temperature change calculation unit 372 of the circuit shown in FIG. 22 and processing carried out in the strain calculation unit 52 may be realized by circuitry such as a microcomputer or a processing unit (PU). In such case, processing may be carried out as shown in the flowchart of FIG. 23.

The flowchart shown in FIG. 23 is basically the same as the flowchart shown in FIG. 21, except that the flowchart of FIG. 23 has additional steps S21, S22, and S15 for a detection of temperature change and for a sensitivity correction based on the detected temperature change.

Regarding the processing shown in the flowchart of FIG. 22, as the processing carried out in the circuitry of the temperature change calculation unit 372, first, when the signal representing the electrical potential difference between the electrodes of the piezoelectric element 32 which has been input from the comparator 441 of the piezoelectric effect detection unit 44 is at low level, the temperature change calculation unit 372 holds the signal which has been input from the resistance calculation unit 748 of the resistance detection unit 740 (a step S21). Next, based on the held resistance, that is, based on the resistance of the resistor 22 when the object is not strained (during the strain non-changing time), the temperature of the resistor 22 (or the temperature of the object where the resistor 22 is fixed) is calculated, and the calculated temperature signal is output to the strain calculation unit 52. Then, in the strain calculation unit 52, based on the input temperature information of the resistor 22, the constant of proportionality used for calculating the strain is corrected (a step S15), and using the corrected constant of proportionality, the strain amount is calculated based on the input accumulated resistance change amount (a step S16).

### REFERENCE SIGNS LISTS

10, 110, 210, 310, 410, 510, 610, 710, 810 . . . Strain measuring system
22, 422, 622 . . . Resistor
32, 432 . . . Piezoelectric element
40, 640 . . . Detection operation unit
42, 642 . . . Resistance detection unit
43 . . . Resistance
44 . . . Piezoelectric effect detection unit
45, 145, 145a, 145b, 245a, 245b . . . Change in electrical potential difference
46, 46a, 46b, 146a, 146b . . . Strain changing time
347a, 347b . . . Strain non-changing time
52, 352 . . . Strain calculation unit
53, 353 . . . Strain resistance change
355 . . . Sensitivity correction unit
356 . . . Non-strain resistance change
62 . . . Load resistor
164 . . . Rectifier
266 . . . Amplifier
372 . . . Temperature change calculation unit
76 . . . Wire
90, 490 . . . Object to be measured
424 . . . Resistor base part
434 . . . Piezoelectric body
436 . . . Lower electrode
438 . . . Upper electrode
490a . . . One plane
490b . . . Other plane
620 . . . Bridge circuit
621a, 621b, 621c . . . Bridge resistor
774 . . . Differential amplifier

What is claimed is:

1. A strain measuring system, comprising:
a piezoelectric element and a resistor provided on an object;
a resistance detection circuit configured to detect a change in resistance of the resistor;
a piezoelectric effect detection circuit configured to detect a piezoelectric effect of the piezoelectric element; and
a strain calculation circuit configured to:
detect a strain changing time while the strain of the object is changing using a detection result from the piezoelectric effect detection circuit,
calculate a change in resistance of the resistor during the strain changing time, and
calculate a degree of strain of the object using a calculation result of the change in resistance.

2. The strain measuring system according to claim 1, further comprising a temperature change calculation circuit configured to:
detect a strain non-changing time which is a period of time when no change occurs in the strain of the object using the detection result from the piezoelectric effect detection circuit,
calculate a change in the resistance of the resistor during the strain non-changing time, and
calculate a temperature change of the resistor.

3. The strain measuring system according to claim 1, wherein the resistor, the piezoelectric element, and the object are at least partially overlapped with each other along a predetermined direction.

4. The strain measuring system according to claim 1, further comprising a bridge circuit including the resistor, wherein the resistance detection circuit detects the change in resistance of the resistor by measuring output of the bridge circuit.

5. The strain measuring system according to claim 1, further comprising a bridge circuit including the resistor and an amplifier configured to amplify an output of the bridge circuit, wherein
the resistance detection circuit detects the change in resistance of the resistor by measuring the output of the bridge circuit amplified by the amplifier.

6. The strain measuring system according to claim 5, wherein the amplifier includes a differential amplifier.

7. The strain measuring system according to claim 1, wherein the resistor and the piezoelectric element are disposed on a same plane.

8. The strain measuring system according to claim 1, wherein the resistor and the piezoelectric element are disposed on different planes.

9. The strain measuring system according to claim 8, wherein the different planes are on opposite sides of the object.

10. The strain measuring system according to claim 1, wherein the resistor is disposed on the object separately from the piezoelectric element.

11. The strain measuring system according to claim 4, wherein the bridge circuit is disposed on the object separately from the piezoelectric element.

12. The strain measuring system according to claim 5, wherein the bridge circuit is disposed on the object separately from the piezoelectric element.

13. The strain measuring system according to claim 1, wherein a longitudinal direction of the resistor and a longitudinal direction of the piezoelectric element align with a longitudinal direction of the object.

14. The strain measuring system according to claim 13, wherein a central axis of the resistor along the longitudinal direction of the resistor, a central axis of the piezoelectric element along the longitudinal direction of the piezoelectric element, and a central axis of the object along the longitudinal direction of the object overlap.

15. The strain measuring system according to claim 1, wherein a longitudinal direction of the resistor and a longitudinal direction of the piezoelectric element do not align with a longitudinal direction of the object.

16. The strain measuring system according to claim 15, wherein a central axis of the resistor along the longitudinal direction of the resistor, a central axis of the piezoelectric element along the longitudinal direction of the piezoelectric element, and a central axis of the object along the longitudinal direction of the object do not overlap.

17. The strain measuring system according to claim 1, wherein the resistor includes at least one of Ni, Cr, Cu, and Al.

18. The strain measuring system according to claim 1, wherein the piezoelectric element includes at least one of barium titanate, lead zirconate titanate, quartz, and zinc oxide.

19. The strain measuring system according to claim 1, wherein the resistor is formed of at least one of a Ni—Cr based alloy, a Cr—Al based alloy, and a Cu—Ni based alloy.

20. The strain measuring system according to claim 1, wherein the resistor is disposed on the object as a thin film.
